(19) United States
(12) Patent Application Publication
(10) Pub. No.: US 2006/0095602 A1
(43) Pub. Date: May 4, 2006

(54) Multi-function system

(76) Inventor: Yuichi Watanabe, Tokyo (JP)

Correspondence Address: RABIN & Berdo, PC, 1101 14TH STREET, NW, SUITE 500, WASHINGTON, DC, 20005, US

(21) Appl. No.: 11/259,271

(22) Filed: Oct. 27, 2005

(30) Foreign Application Priority Data
Oct. 28, 2004 (JP) JP2004-313444

(51) Int. Cl. G06F 3/00

(52) U.S. Cl. 710/16

(57) ABSTRACT

A multi-function system in which one of plural peripheral apparatuses is connected as a parent peripheral apparatus to an upper apparatus having a peripheral apparatus driver for making the peripheral apparatuses operative and the residual peripheral apparatuses are connected as child peripheral apparatuses to the parent peripheral apparatus. The parent peripheral apparatus has a descriptor transmitting unit which forms and transmits peripheral apparatus descriptors to device-define the parent and child peripheral apparatuses. The upper apparatus has a first control unit which activates the corresponding driver every descriptor reception and gives ID information and a data communicating unit which forms and transmits ID communication data for specifying a transmission destination of communication data to each peripheral apparatus. The parent peripheral apparatus has a peripheral apparatus control unit which analyzes the received ID communication data to discriminate a transfer destination and transfers the communication data.

### BACKGROUND OF THE INVENTION

1. Field of the Invention

The invention relates to a multi-function system constructed by an upper apparatus and peripheral apparatuses connected thereto by a USB (Universal Serial Bus) and, more particularly, to a multi-function system which can improve business processing efficiency by enabling the multi-operation of a plurality of functions and easily realize addition of peripheral apparatuses.

2. Related Background Art

A multi-function system in which an upper apparatus such as a PC or the like is connected to a plurality of peripheral apparatuses by a USB has been known. The USB has common bus specifications for connecting the upper apparatus and the peripheral apparatuses. The peripheral apparatuses of different applications such as scanner, printer, and the like can be connected to the upper apparatus by the USB. The upper apparatus can establish communication with each of the connected peripheral apparatuses on the basis of a USB communication protocol.

According to the USB, the peripheral apparatus can be attached and detached to/from the upper apparatus in the state where the upper apparatus is operating (state where a power source is ON). When a new peripheral apparatus is connected to the upper apparatus or the connected peripheral apparatus is detached therefrom, a system is automatically reconstructed by a USB controller (IC to automatically construct a system when the peripheral apparatus is detached from the upper apparatus). Therefore, the peripheral apparatus can be added and changed without executing reactivation, setup operation, and the like to the upper apparatus. Consequently, since the upper apparatus has established the communication every connected peripheral apparatus, the peripheral apparatuses can be made operative in parallel from the upper apparatus.

In the multi-function system as mentioned above, the USB controller to connect a plurality of peripheral apparatuses to the upper apparatus is necessary. According to the USB controller, since a design of the IC to perform the automatic construction of the system in association with the addition and change of the peripheral apparatus becomes complicated, there is such a problem that the USB controller is expensive and the costs rise.

To solve the above problem, a multi-function system in which a multi-function apparatus that can provide a plurality of functions such as scanner function, printer function, FAX function, and the like is connected to an upper apparatus has been proposed (refer to JP-A-2001-222503). Since such a multi-function system has a construction in which one multi-function apparatus is connected to the upper apparatus, the expensive USB controller for supporting the connection of a plurality of peripheral apparatuses does not need to be provided for the upper apparatus and the problem of the increase in costs can be solved.

However, the multi-function system disclosed in JP-A-2001-222503 has the following problems to be solved. That is, by constructing the system by connecting the multi-function apparatus to the upper apparatus, the increase in costs as mentioned above can be prevented. However, since the upper apparatus and the multi-function apparatus are connected by one communication line and the multi-function apparatus is recognized as a peripheral apparatus having only one of a plurality of functions on the upper apparatus side, the upper apparatus can make only one selected function operative and a plurality of functions cannot be operated in parallel.

Therefore, for example, when the printer function is selected by the upper apparatus and printing is executed, since the multi-function apparatus operates as an image output apparatus, it cannot use the scanner function. In the case of using the scanner function, after the printing by the printer function is finished, it is necessary to execute the function switching for the multi-function apparatus from the upper apparatus and reconstruct the system. Thus, the high efficiency of the business process cannot be realized.

To allow the upper apparatus to establish the communication with the multi-function apparatus, it is necessary to additionally develop a driver for the multi-function apparatus. Since there are various kinds of basic software (hereinbelow, referred to as “OS”) to be supported, it is necessary to develop the multi-function apparatus driver every OS. Further, it is necessary to also develop a function switching driver for allowing the upper apparatus to execute the switching of a plurality of functions installed in the multi-function apparatus. Therefore, the developing work of both of the foregoing drivers is accompanied in order to add the function to the multi-function system disclosed in JP-A-2001-222503, so that the function addition cannot be easily realized.

### SUMMARY OF THE INVENTION

It is, therefore, an object of the invention to provide a multi-function system which can improve business processing efficiency by enabling the multi-operation of a plurality of functions and easily realize addition of peripheral apparatuses.

According to the present invention, there is provided a multi-function system in which one of a plurality of peripheral apparatuses is connected as a specific parent peripheral apparatus to an upper apparatus and the residual peripheral apparatuses are connected as child peripheral apparatuses to the parent peripheral apparatus, wherein

the parent peripheral apparatus has a descriptor transmitting unit which transmits peripheral apparatus descriptors, necessary for defining the parent peripheral apparatus and the child peripheral apparatus to the upper apparatus,

the upper apparatus has

a first control unit which gives identification information to the parent peripheral apparatus and the child peripheral apparatuses on the basis of the peripheral apparatus descriptors each time the peripheral apparatus descriptors are received and

a data communicating unit which forms identification communication data to specify the parent peripheral apparatus and the child peripheral apparatuses serving as transmission destinations of communication data to be transmitted to each of the peripheral apparatuses and transmits the identification communication data to the parent peripheral apparatus, and

further, the parent peripheral apparatus has a peripheral apparatus control unit which, when the identification communication data is received, analyzes the identification communication data, obtains the identification information, discriminates a transfer destination of the communication data on the basis of the identification information, and transfers the communication data.

Moreover, in the multi-function system, the parent peripheral apparatus may be an image input apparatus and the child peripheral apparatus may be an image output apparatus.

Moreover, in the multi-function system, the parent peripheral apparatus may have a second control unit which, when the peripheral apparatus descriptor is received from the child peripheral apparatus, makes the device definition of the child peripheral apparatus in the parent peripheral apparatus on the basis of the peripheral apparatus descriptor and gives the identification information to the child peripheral apparatus.

Moreover, in the multi-function system, the parent peripheral apparatus may be a scanner, the child peripheral apparatus may be a printer.

Moreover, in the multi-function system, the upper apparatus may be connected with the scanner via USB cable, and the scanner may be connected with the printer via USB cable.

Moreover, in the multi-function system, when the peripheral apparatus control unit judges the communication data should be processed by its own on the basis of the identification information, the scanner can execute scanning process to obtain image process data on the basis of the communication data.

Moreover, in the multi-function system, the printer, when received the communication data from the peripheral apparatus control unit, can execute printing process on the basis of the communication data.

Moreover, in the multi-function system, the scanner may further include a operation unit to receive an input of instruction data for executing copying process containing a scanning process and a printing process; and a copy control unit, when the instruction data is input to the operation unit, to execute the scanning process on the basis of the instruction data for obtaining image process data and to send the obtained image process data to the printer, and the printer, when received the image process data, can execute the printing process on the basis of the image process data.

Further, according to the present invention, there is provided an image input apparatus to which at least one peripheral apparatus has been connected as a child peripheral apparatus and which receives communication data that is outputted from an upper apparatus and should be supplied to either its own apparatus or the peripheral apparatus, comprising:

a descriptor transmitting unit which transmits peripheral apparatus descriptors necessary for defining the own apparatus and the peripheral apparatus to the upper apparatus; and

a peripheral apparatus control unit which, when identification communication data to specify a transmission destination including identification information showing either the own apparatus or the peripheral apparatus is received from the upper apparatus, analyzes the identification communication data, and when the identification information indicates the peripheral apparatus, transfers the communication data to the peripheral apparatus.

According to the invention, in order to allow the upper apparatus to establish the communication with the parent peripheral apparatus and the child peripheral apparatus, the parent peripheral apparatus transmits the descriptors for the parent peripheral apparatus and the child peripheral apparatus to the upper apparatus and the upper apparatus establishes the communication with each of the parent peripheral apparatus and the child peripheral apparatus on the basis of both of the descriptors, so that the upper apparatus can recognize the parent peripheral apparatus and the child peripheral apparatus connected to the parent peripheral apparatus.

Therefore, since the upper apparatus can allow the parent peripheral apparatus and the child peripheral apparatus to execute the multi-operation, the business processing efficiency can be improved.

Since each of the parent peripheral apparatus and the child peripheral apparatus can be recognized by the upper apparatus, there is no need to provide an expensive USB controller for the upper apparatus.

Further, in the case of adding a new peripheral apparatus, since the peripheral apparatus driver of the peripheral apparatuses is used, the peripheral apparatus can be added without developing a new peripheral apparatus driver. Thus, the addition of the function can be easily realized.

The above and other objects and features of the present invention will become apparent from the following detailed description and the appended claims with reference to the accompanying drawings.

### BRIEF DESCRIPTION OF THE DRAWINGS

FIG. 1 is a diagram showing an embodiment of the invention;

FIG. 2 is a block constructional diagram of an upper apparatus in the invention;

FIG. 3 is a block constructional diagram of an image input apparatus in the invention;

FIG. 4 is a block constructional diagram of an image output apparatus in the invention;

FIG. 5 is a flowchart for the communication establishing operation in the image input apparatus and the image output apparatus;

FIG. 6 is a flowchart for the operation to establish communication between the upper apparatus and the image input apparatus to which the image output apparatus is connected;

FIG. 7 is an operation flowchart for a PC scan function;

FIG. 8 is an operation flowchart for a PC print function; and

FIG. 9 is an operation flowchart for a PC copy function.

### DETAILED DESCRIPTION OF THE PREFERRED EMBODIMENT

An embodiment of the invention will be described in detail hereinbelow with reference to the drawings.

### Embodiment

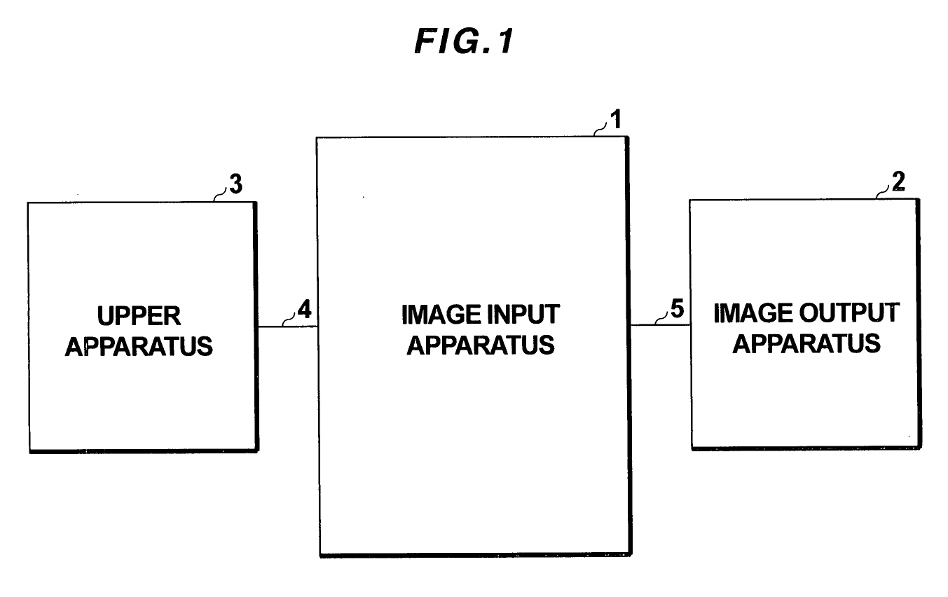

FIG. 1 is a diagram showing the embodiment of the invention.

A multi-function system in the embodiment is constructed by an image input apparatus 1 as a parent peripheral apparatus, an image output apparatus 2 as a child peripheral apparatus, and an upper apparatus 3. The image output apparatus 2 and the upper apparatus 3 are connected to the image input apparatus 1 by USB cables 4 and 5, respectively.

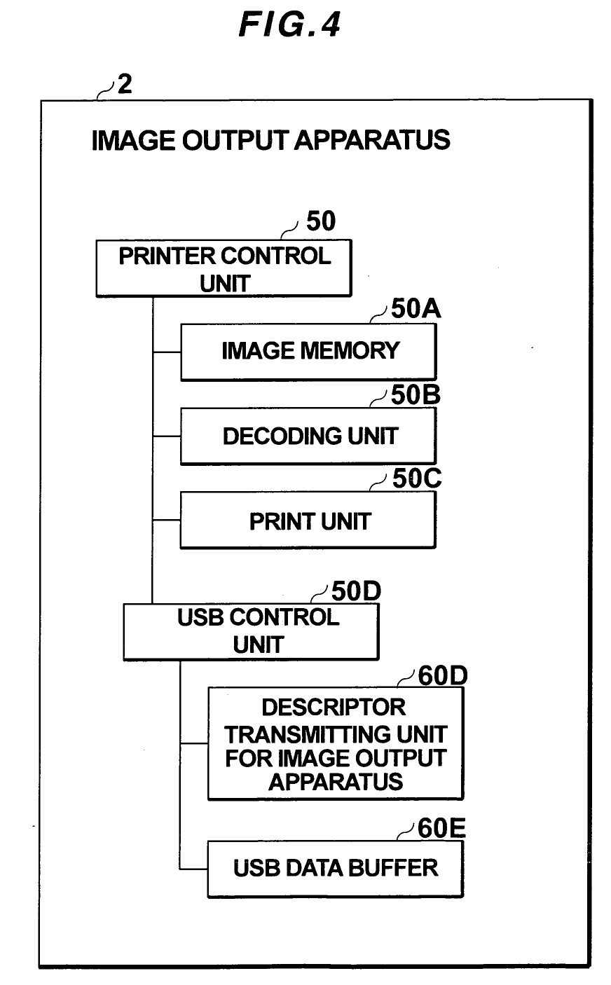

FIG. 4 is a block constructional diagram of the image. output apparatus 2 in the embodiment.

The image output apparatus 2 has a printer control unit 50 for making whole control in a print process of the image output apparatus 2.

An image memory 50A, a decoding unit 50B, a print unit 50C, and a USB control unit 50D are connected to the printer control unit 50.

The USB control unit 50D controls data communication between the image input apparatus 1 and the image output apparatus 2 connected by USB connection. A descriptor transmitting unit 60D for the image output apparatus and a USB data buffer 60E are connected to the USB control unit 50D.

When the descriptor transmitting unit 60D for the image output apparatus receives a descriptor request signal from the USB control unit 50D, in order to establish the communication between the image input apparatus 1 and the image output apparatus 2, the unit 60D forms a descriptor for the image output apparatus and transmits the formed descriptor for the image output apparatus to a USB control unit 101 of the image input apparatus 1 through the USB control unit 50D. The descriptor for the image output apparatus is information showing the kinds of functions held in the image output apparatus 2 and is stored in a memory which is not shown. By this information, the image input apparatus 1 specifies the function of the image output apparatus 2 on the basis of the received descriptor for the image output apparatus, allows the identification (ID) information corresponding to the image output apparatus 2 is held into a memory 20F, and transmits the ID information to a memory (not shown) of the image output apparatus 2, thereby establishing the communication between the image input apparatus 1 and the image output apparatus 2.

The USB data buffer 60E is a memory in which the compression image processing data formed by the upper apparatus 3 or the image input apparatus 1 as will be explained hereinafter is temporarily stored in order to allow the image output apparatus 2 to print.

The image memory 50A is a memory in which the image processing data decoded by the decoding unit 50B, which will be explained hereinafter, is temporarily stored.

When the compression image processing data formed by a peripheral apparatus driver of the upper apparatus 3 or by the image input apparatus 1 is received through the USB control unit 50D, the decoding unit 50B decodes the compression image processing data, obtains the image processing data, and stores the image processing data into the image memory 50A.

When a print instruction signal is received from the printer control unit 50, the print unit 50C obtains the image processing data from the image memory 50A and executes the print process based on the image processing data.

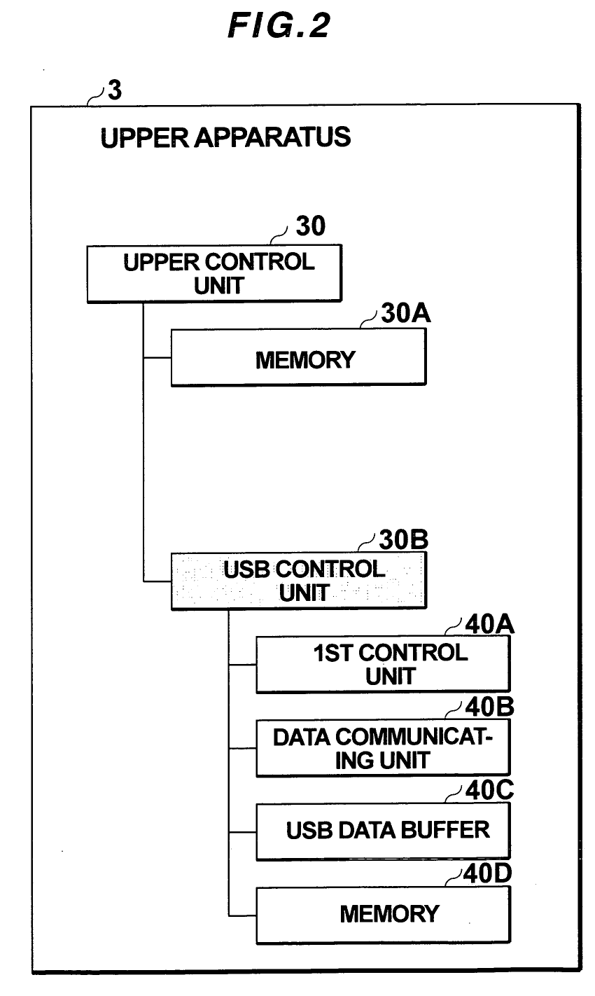

FIG. 2 is a block constructional diagram of the upper apparatus 3 in the embodiment.

For example, a personal computer (PC) or the like having an input terminal such as a keyboard or the like and an output terminal such as a monitor or the like is used as an upper apparatus 3. The upper apparatus 3 has an upper control unit 30 which makes whole control of the upper apparatus 3.

Further, a memory 30A and a USB control unit 30B are connected to the upper control unit 30.

A driver for the image input apparatus and a driver for the image output apparatus each for allowing the upper apparatus 3 to control the operations of the peripheral apparatuses have been stored in the memory 30A.

Thus, when the peripheral apparatus is selected by the input terminal of the upper apparatus 3, a peripheral apparatus selection signal is outputted to the upper control unit 30. On the basis of the peripheral apparatus selection signal, the upper control unit 30 selects the corresponding peripheral apparatus driver from the memory 30A and allows the selected peripheral apparatus driver to display an instruction setting display screen for receiving an operation control instruction of the peripheral apparatus through the output terminal.

For example, when the image input apparatus 1 is selected, the driver for the image input apparatus is selected from the memory 30A by the upper control unit 30 and this driver displays the instruction setting display screen through the output terminal.

When the operator inputs reading instruction data such as resolution designation or the like to read an original as image data, image processing instruction data such as color designation or the like to the read image data, and compression instruction data such as compression ratio designation or the like of the image data on the basis of the instruction setting display screen, the driver for the image input apparatus forms setting instruction data on the basis of all of the instruction data and transfers the setting instruction data to a data communicating unit 40B, which will be explained hereinafter, through the USB control unit 30B.

For example, when the image output apparatus 2 is selected, the driver for the image output apparatus is selected from the memory 30A by the upper control unit 30 and this driver displays the instruction setting display screen through the output terminal.

When the operator inputs the image processing instruction data and the compression instruction data on the basis of the instruction setting display screen, the driver for the image output apparatus executes an image process to the image data as a print target and forms image processing data. After that, the driver for the image output apparatus subsequently executes a compressing process to the image processing data on the basis the compression instruction data, forms the compression image processing data, and transfers the compression image processing data to the data communicating unit 40B, which will be explained hereinafter, through the USB control unit 30B.

The USB control unit 30B controls the data communication by the USB connection. The data communicating unit 40B, a first control unit 40A, a USB data buffer 40C, and a memory 40D are connected to the USB control unit 30B.

When a connection signal is outputted from the image input apparatus 1 in order to make device definition of the upper apparatus 3 and the image input apparatus 1 to which the image output apparatus 2 is connected, the USB control unit 30B outputs a request instruction signal of a descriptor to the image input apparatus 1. As will be explained hereinafter, a descriptor for the peripheral apparatus is formed by the image input apparatus 1 and transmitted to the upper apparatus 3.

When the USB control unit 30B transfers the received descriptor for the peripheral apparatus to the first control unit 40A, the first control unit 40A holds it into the memory (not shown), sequentially specifies the functions of the peripheral apparatus on the basis of the descriptor for the peripheral apparatus, holds the ID information corresponding to the peripheral apparatus into the memory 40D, and transmits the ID information to the memory 20F of the image input apparatus 1, thereby establishing the communication between the upper apparatus 3 and the image input apparatus 1 to which the peripheral apparatus is connected.

When the setting instruction data is received from the driver for the image input apparatus so that the image input apparatus 1 can specify the transmission destination of the data formed by each peripheral apparatus driver, the data communicating unit 40B obtains the ID information of the corresponding image input apparatus 1 with reference to the memory 40D on the basis of the driver for the image input apparatus of the transmitting source side, forms identification (ID) setting instruction data by inserting the ID information into the setting instruction data, and transfers the ID setting instruction data to the USB data buffer 40C.

When the compression image processing data is received from the driver for the image output apparatus, the data communicating unit 40B obtains the ID information of the corresponding image output apparatus 2 with reference to the memory 40D on the basis of the driver for the image output apparatus of the transmitting source side, forms identification (ID) compression image processing data by inserting the ID information into the compression image processing instruction data, and transfers the identification compression image processing data to the USB data buffer 40C.

The USB data buffer 40C is a memory in which the identification compression setting instruction data and the identification compression image processing data which are formed by the upper apparatus 3 and should be transmitted to the image input apparatus 1 as will be explained hereinafter are temporarily stored. The compression image processing data which is transmitted from the image input apparatus 1 is also temporarily stored into the USB data buffer 40C.

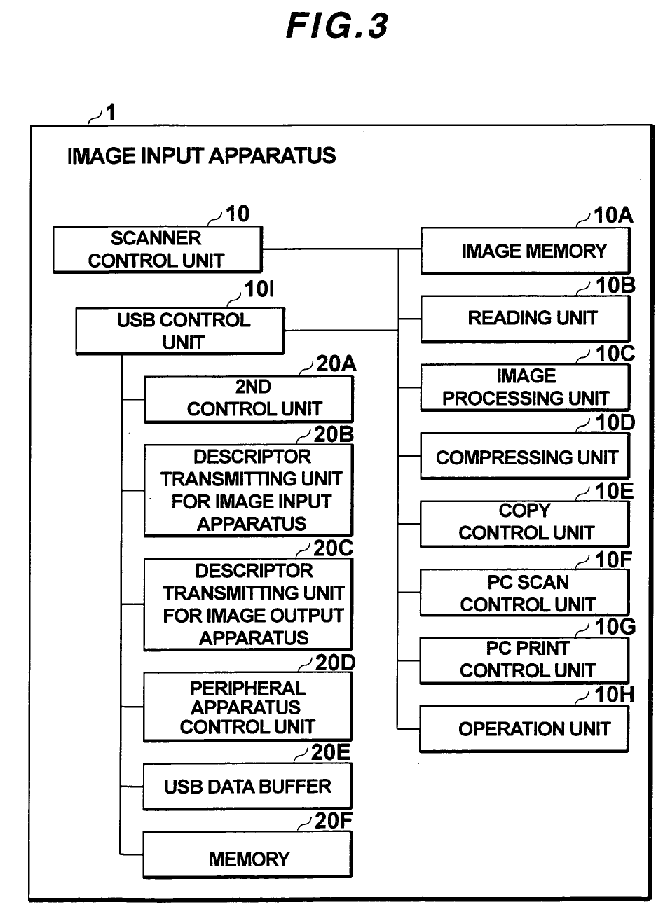

FIG. 3 is a block constructional diagram of the image input apparatus 1 in the embodiment.

The image input apparatus 1 in the embodiment has a scanner control unit 10 for making whole control of the image input apparatus 1.

Further, an image memory 10A, a reading unit 10B, an image processing unit 10C, a compressing unit 10D, a copy control unit 10E, a PC scan control unit 10F, a PC print control unit 10G, an operation unit 10H, and the USB control unit 10I are connected to the scanner control unit 10.

The USB control unit 10I controls the data communication by the USB connection. A second control unit 20A, a descriptor transmitting unit 20B for the image input apparatus, a descriptor transmitting unit 20C for the image output apparatus, a peripheral apparatus control unit 20D, a USB data buffer 20E, and the memory 20F are connected to the USB control unit 10I.

When the descriptor for the image output apparatus is received from the descriptor transmitting unit 60D for the image output apparatus of the image output apparatus 2 so as to allow the image input apparatus 1 to establish the communication with the image output apparatus 2 by the USB connection, the second control unit 20A determines the function of the image output apparatus 2 on the basis of the descriptor for the image output apparatus, holds the ID information corresponding to the image output apparatus 2 into the memory 20F, and transmits the ID information to the memory (not shown) of the image output apparatus 2, thereby establishing the USB communication between the image input apparatus 1 and the image output apparatus 2.

When the descriptor request signal is received from the upper apparatus 3, the USB control unit 10I specifies the peripheral apparatus connected to the image input apparatus 1 with reference to the memory 20F.

That is, when the ID information corresponding to the peripheral apparatus is not stored in the memory 20F, the USB control unit 10I determines that the peripheral apparatus is not connected to the image input apparatus 1, and transmits the descriptor request signal to the descriptor transmitting unit 20B for the image input apparatus, which will be explained hereinafter.

If the ID information corresponding to the peripheral apparatus has been stored in the memory 20F, the USB control unit 10I determines that the peripheral apparatus has been connected to the image input apparatus 1, and transmits the descriptor request signal to the corresponding descriptor transmitting unit for the peripheral apparatus and the descriptor transmitting unit 20B for the image input apparatus.

In the embodiment, since only the image output apparatus 2 is connected to the image input apparatus 1 and the ID information corresponding to the image output apparatus 2 has been stored in the memory 20F, the USB control unit 10I transmits the descriptor request signal to the descriptor transmitting unit 20B for the image input apparatus and the descriptor transmitting unit 20C for the image output apparatus.

When the descriptor request signal is received from the USB control unit 10I, the descriptor transmitting unit 20C for the image output apparatus transmits the descriptor for the image output apparatus to the upper apparatus 3 in order to establish the communication between the upper apparatus 3 and the image output apparatus 2.

When the descriptor request signal is received from the USB control unit 10I, the descriptor transmitting unit 20B for the image input apparatus transmits the descriptor for the image input apparatus to the upper apparatus 3 in order to establish the communication between the upper apparatus 3 and the image input apparatus 1.

The peripheral apparatus control unit 20D discriminates a transfer destination of the data which is transmitted from the upper apparatus 3. When the identification setting instruction data is received from the upper apparatus 3, the peripheral apparatus control unit 20D analyzes the identification setting instruction data and obtains the ID information and the setting instruction data. When it is determined on the basis of the ID information that the transfer destination of the setting instruction data is the image input apparatus 1 with reference to the memory 20F, the peripheral apparatus control unit 20D transfers the setting instruction data to the PC scan control unit 10F.

When the identification compression image processing data is received from the upper apparatus 3, the peripheral apparatus control unit 20D analyzes the identification compression image processing data and obtains the ID information and the compression image processing data. When it is determined on the basis of the ID information that the transfer destination of the compression image processing data is the image output apparatus 2 with reference to the memory 20F, the peripheral apparatus control unit 20D transfers the compression image processing data to the PC print control unit 10G.

When the setting instruction data is received from the peripheral apparatus control unit 20D through the USB control unit 10I, the PC scan control unit 10F analyzes the setting instruction data, obtains the reading instruction data, image processing instruction data, and compression instruction data, respectively, holds those data into the memory (not shown), and controls the reading unit 10B, image processing unit 10C, and compressing unit 10D, which will be explained hereinafter, so as to make scan control based on each data.

When the compression image processing data is received from the peripheral apparatus control unit 20D through the USB control unit 10I, the PC print control unit 10G transfers the compression image processing data to the USB data buffer 20E of the USB control unit 10I.

The USB data buffer 20E is a memory in which the identification compression setting instruction data and the identification compression image processing data which are formed by the upper apparatus 3 and should be transmitted to the image input apparatus 1 are temporarily stored. The compression image processing data which should be transmitted to the upper apparatus 3 or the image output apparatus 2 is also temporarily stored in the USB data buffer 20E.

The operation unit 10H has an input unit such as touch panel, keyboard, or the like and an output unit such as a liquid crystal panel or the like and displays an instruction setting display screen which receives an operation control instruction of the image input apparatus 1 through the output unit in order to make copy control.

When the operator inputs the reading instruction data such as resolution designation or the like to read the original as image data, the image processing instruction data such as color designation or the like to the read image data, and the compression instruction data such as compression ratio designation or the like of the image data on the basis of the instruction setting display screen, the operation unit 10H transfers the received data to the copy control unit 10E.

When the reading instruction data, image processing instruction data, and compression instruction data are received from the operation unit 10H, respectively, the copy control unit 10E holds the received instruction data into the memory (not shown) and controls the reading unit 10B, image processing unit 10C, and compressing unit 10D, which will be explained hereinafter, so as to make the copy control based on each instruction data.

The reading unit 10B has an original sheet setting board to set an original to be read. When the reading instruction data is received from the PC scan control unit 10F or the copy control unit 10E, the reading unit 10B reads the original set on the original sheet setting board as image data and stores the image data into the image memory 10A. After the image data is stored in the image memory 10A, the reading unit 10B outputs a reading process completion signal to the PC scan control unit 10F or the copy control unit 10E.

The image memory 10A is a memory in which the data processed by the image processing unit 10C and the compressing unit 10D, which will be explained hereinafter, is temporarily stored, respectively.

When the image processing instruction data is received from the PC scan control unit 10F or the copy control unit 10E, the image processing unit 10C obtains the image data from the image memory 10A, forms image processing data on the basis of the image processing instruction data, and stores the image processing data into the image memory 10A. After the image processing data is stored in the image memory 10A, the image processing unit 10C outputs an image process completion signal to the PC scan control unit 10F or the copy control unit 10E.

When the compression instruction data is received from the PC scan control unit 10F or the copy control unit 10E, the compressing unit 10D obtains the image processing data from the image memory 10A, forms compression image processing data on the basis of the compression instruction data, and stores the compression image processing data into the image memory 10A. After the compression image processing data is stored in the image memory 10A, the compressing unit 10D outputs a compressing process completion signal to the PC scan control unit 10F or the copy control unit 10E.

Subsequently, the operation of the multi-function system in the embodiment will be described.

First, the establishment of the communication between the image input apparatus 1 and the image output apparatus 2 in the USB connection will be described.

It is assumed that the upper apparatus 3, image input apparatus 1, and image output apparatus 2 are in the state where a power source (not shown) is ON.

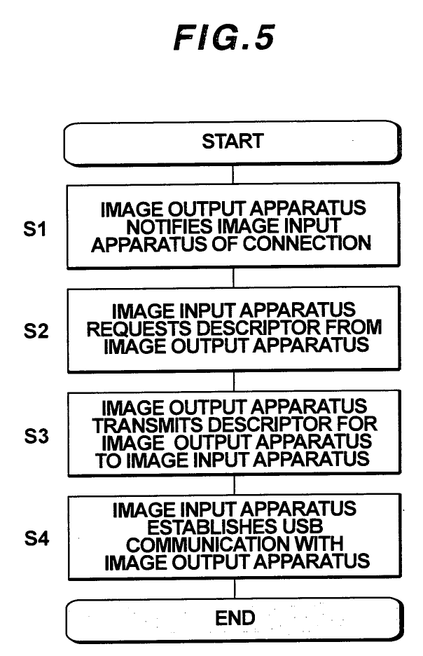

FIG. 5 is a flowchart for the communication establishing operation in the image input apparatus 1 and the image output apparatus 2.

When the image output apparatus 2 is connected to the image input apparatus 1 by the USB cable 5, the USB control unit 50D of the image output apparatus 2 transmits a USB connection notification signal to the USB control unit 10I of the image input apparatus 1 (step S1).

When the USB connection notification signal is received, the USB control unit 10I transmits the descriptor request signal to the USB control unit 50D of the image output apparatus 2 (step S2).

When the descriptor request signal is received, the USB control unit 50D transfers the descriptor request signal to the descriptor transmitting unit 60D for the image output apparatus.

When the descriptor request signal is received, the descriptor transmitting unit 60D for the image output apparatus forms a descriptor for the image output apparatus and transfers the descriptor for the image output apparatus to the USB control unit 50D.

When the descriptor for the image output apparatus is transferred, the USB control unit 50D transmits the descriptor for the image output apparatus to the USB control unit 10I of the image input apparatus 1 (step S3).

When the descriptor for the image output apparatus is received, the USB control unit 10I transfers the descriptor for the image output apparatus to the second control unit 20A.

When the descriptor for the image output apparatus is received from the descriptor transmitting unit 60D for the image output apparatus of the image output apparatus 2, the second control unit 20A determines the function of the image output apparatus 2 on the basis of the descriptor for the image output apparatus, stores the ID information corresponding to the image output apparatus 2 into the memory 20F, and transmits the ID information into the memory (not shown) of the image output apparatus 2, thereby establishing the USB communication between the image input apparatus 1 and the image output apparatus 2 (step S4).

The establishment of the communication between the upper apparatus 3 and the image input apparatus 1 to which the image output apparatus 2 is connected will now be described.

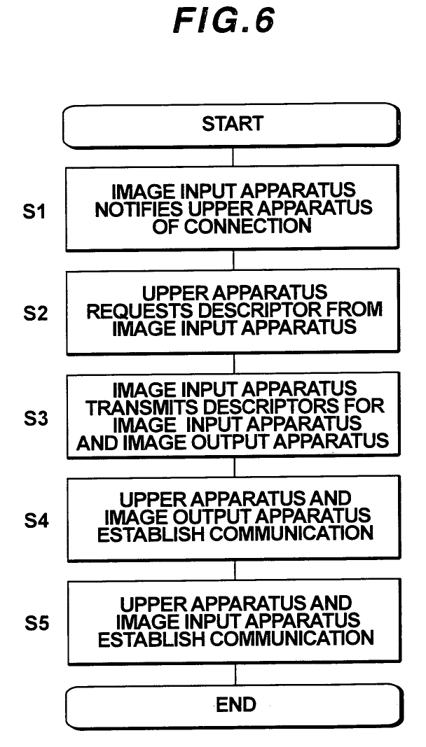

FIG. 6 is a flowchart for the operation which is executed until the communication is established between the upper apparatus 3 and the image input apparatus 1 to which the image output apparatus 2 is connected.

When the image input apparatus 1 whose communication has been established with the image output apparatus 2 is USB-connected to the upper apparatus 3 as mentioned above, the USB control unit 10I of the image input apparatus 1 transmits a connection notification signal to the USB control unit 30B of the upper apparatus 3 (step S1).

When the connection notification signal is received, the USB control unit 30B transmits a descriptor request signal to the USB control unit 10I of the image input apparatus 1 (step S2).

When the descriptor request signal is received, the USB control unit 10I refers to the memory 20F in order to specify the peripheral apparatus connected to the image input apparatus 1. In the embodiment, since the ID information corresponding to the image output apparatus 2 has been stored in the memory 20F, the USB control unit 10I determines that the image output apparatus 2 has been connected to the image input apparatus 1 on the basis of the ID information. The USB control unit 10I transfers the descriptor request signal to the descriptor transmitting unit 20C for the image output apparatus and the descriptor transmitting unit 20B for the image input apparatus.

When the descriptor request signal is received, the descriptor transmitting unit 20C for the image output apparatus and the descriptor transmitting unit 20B for the image input apparatus transmits the descriptor for the image output apparatus and the descriptor for the image input apparatus, respectively, to the USB control unit 10I.

The USB control unit 10I transmits both of the received descriptors to the USB control unit 30B of the upper apparatus 3.

The USB control unit 30B of the upper apparatus 3 transfers both of the received descriptors to the first control unit 40A (step S3).

The first control unit 40A holds both of the descriptors received from the USB control unit 30B into the memory (not shown), first specifies the function of the image output apparatus 2 on the basis of the held descriptor for the image output apparatus, holds the ID information corresponding to the image output apparatus 2 into the memory 40D, and transmits the ID information to the memory 20F of the image input apparatus 1, thereby establishing the communication between the upper apparatus 3 and the image output apparatus 2 (step S4).

Subsequently, the first control unit 40A specifies the function of the image input apparatus 1 on the basis of the held descriptor for the image input apparatus, holds the ID information corresponding to the image input apparatus 1 into the memory 40D, and transmits the ID information to the memory 20F of the image input apparatus 1, thereby establishing the communication between the upper apparatus 3 and the image input apparatus 1 (step S5).

As mentioned above, since the image input apparatus 1 whose USB communication has been established with the image output apparatus 2 transmits the descriptor for the image input apparatus and the descriptor for the image output apparatus and establishes the USB communication with the upper apparatus 3. Therefore, the upper apparatus 3 can recognize the image input apparatus 1 and the image output apparatus 2 connected to the image input apparatus 1. That is, as a multi-function system, the communication can be made from the upper apparatus side in accordance with a USB protocol and the image input apparatus 1 and the image output apparatus 2 can be made operative.

Subsequently, the operations of the PC scan function, PC print function, and copy function by the multi-function system constructed as mentioned above will be described.

First, the PC scan function using the upper apparatus 3 and the image input apparatus 1 will be described.

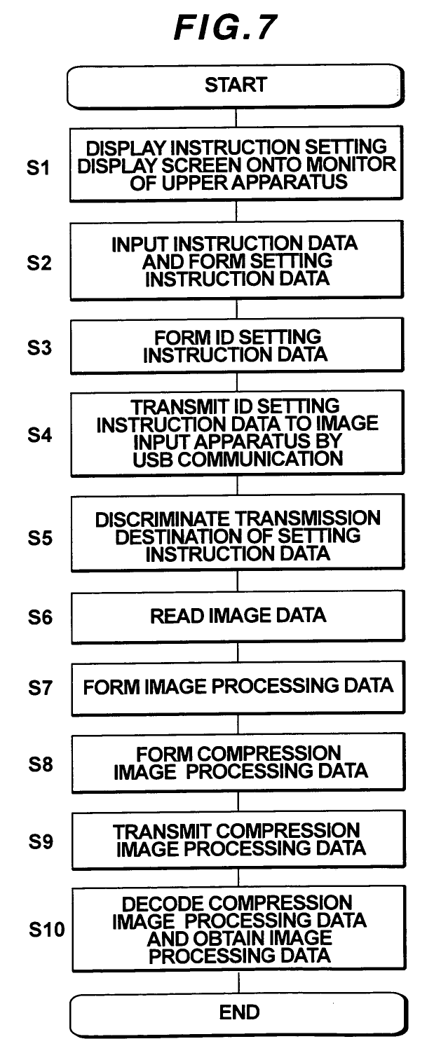

FIG. 7 is an operation flowchart for the PC scan function.

When an original is put in the reading unit 10B of the image input apparatus 1 and the operator inputs a peripheral apparatus selection signal to select the image input apparatus 1 from the input terminal of the upper apparatus 3 to the upper control unit 30, the upper control unit 30 selects the driver for the image input apparatus on the basis of the peripheral apparatus selection signal and instructs the driver for the image input apparatus to display an instruction setting display screen.

When the instruction to display the instruction setting display screen is received, the driver for the image input apparatus displays the instruction setting display screen through the output terminal (step Si). Thus, on the basis of the instruction setting display screen, the operator can input the reading instruction data such as resolution designation or the like to read the original, as image data, which is necessary for the operation control of the image input apparatus 1, the image processing instruction data such as color designation or the like to the read image data, and the compression instruction data such as compression ratio designation or the like of the image data.

When those instruction data is inputted by the operator, the driver for the image input apparatus forms setting instruction data on the basis of all of the instruction data and the upper control unit 30 transfers the setting instruction data to the USB control unit 30B (step S2).

When the setting instruction data is transferred, the USB control unit 30B transfers the setting instruction data to the data communicating unit 40B.

When the setting instruction data is received, the data communicating unit 40B refers to the memory 40D, obtains the ID information of the corresponding image input apparatus 1 on the basis of the driver for the image input apparatus of the transmitting source side, and inserts the ID information into the setting instruction data, thereby forming identification setting instruction data and transferring the identification setting instruction data to the USB data buffer 40C (step S3).

When the identification setting instruction data is transferred to the USB data buffer 40C, the USB control unit 30B transmits the identification setting instruction data to the USB data buffer 20E through the USB control unit 10I of the image input apparatus 1 (step S4).

When the identification setting instruction data is received to the USB data buffer 20E, the USB control unit 101 transfers the identification setting instruction data to the peripheral apparatus control unit 20D.

The peripheral apparatus control unit 20D analyzes the received identification setting instruction data. When the ID information and the setting instruction data of the image input apparatus 1 are obtained, the peripheral apparatus control unit 20D determines on the basis of the ID information that the transfer destination of the setting instruction data is the image input apparatus 1, and transfers the setting instruction data to the PC scan control unit 10F (step S5).

The PC scan control unit 10F analyzes the received setting instruction data, obtains the reading instruction data, image processing instruction data, and compression instruction data, respectively, and transfers the reading instruction data to the reading unit 10B.

The reading unit 10B reads the original on the basis of the received reading instruction data, obtains the image data, stores the image data into the image memory 10A, and outputs a reading process completion signal to the PC scan control unit 10F (step S6).

When the reading process completion signal is received, the PC scan control unit 10F transfers the image processing instruction data to the image processing unit 10C.

When the image processing instruction data is received from the PC scan control unit 10F, the image processing unit 10C obtains the image data from the image memory 10A, executes the image process to the image data on the basis of the image processing instruction data, forms image processing data, stores the image processing data into the image memory 10A, and outputs an image process completion signal to the PC scan control unit 10F (step S7).

When the image process completion signal outputted by the image processing unit 10C is received, the PC scan control unit 10F transfers the compression instruction data to the compressing unit 10D.

When the compression instruction data is received from the PC scan control unit 10F, the compressing unit 10D obtains the image processing data from the image memory 10A, executes a compressing process to the image processing data on the basis of the compression instruction data, forms compression image processing data, stores the compression image processing data into the image memory 10A, and outputs a compressing process completion signal to the PC scan control unit 10F (step S8).

When the compressing process completion signal outputted by the compressing unit 10D is received, the PC scan control unit 10F obtains the compression image processing data from the image memory 10A and transfers the compression image processing data to the USB data buffer 20E of the USB control unit 10I.

When the compression image processing data is transferred to the USB data buffer 20E from the PC scan control unit 10F, the USB control unit 10I transmits the compression image processing data to the USB data buffer 40C through the USB control unit 30B of the upper apparatus 3 (step S9).

When the compression image processing data is transferred to the USB data buffer 40C of the USB control unit 30B, the USB control unit 30B transfers the compression image processing data to the driver for the image input apparatus.

When the compression image processing data is transferred to the driver for the image input apparatus, the driver for the image input apparatus executes the decoding process to the compression image processing data and obtains the image processing data, so that the PC scan process is completed (step S10).

The operation of the PC print function using the multi-function system of the invention will now be described.

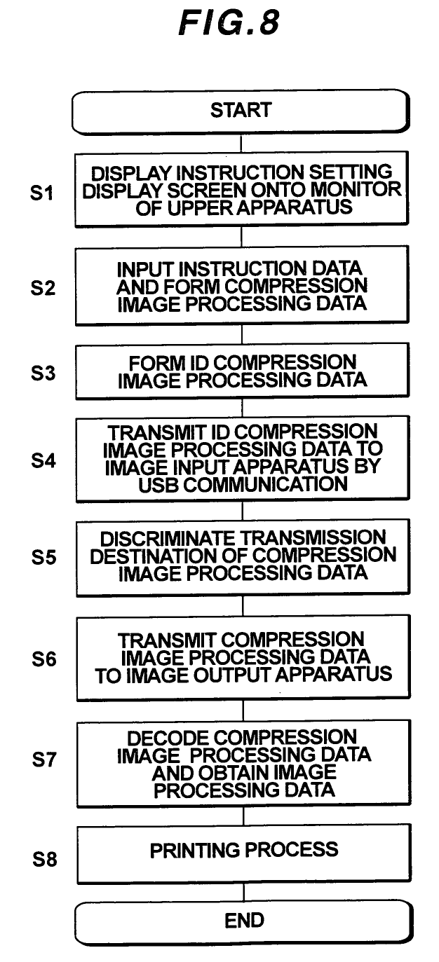

FIG. 8 is an operation flowchart for the PC print function.

When the operator inputs the peripheral apparatus selection signal to select the image output apparatus 2 to the upper control unit 30 from the input terminal of the upper apparatus 3, the upper control unit 30 selects the driver for the image output apparatus on the basis of the peripheral apparatus selection signal and instructs the driver for the image output apparatus to display the instruction setting display screen.

When the display instruction of the instruction setting display screen is received, the driver for the image output apparatus displays the instruction setting display screen through the output terminal (step S1).

Subsequently, when the image processing instruction data and the compression instruction data are inputted by the operator on the basis of the instruction setting display screen, the driver for the image output apparatus executes the image process to the image data as a print target on the basis of the image processing instruction data, forms image processing data, after that, subsequently executes the compressing process to the image processing data on the basis of the compression instruction data, forms compression image processing data, and transfers the compression image processing data to the USB control unit 30B (step S2).

When the compression image processing data is transferred, the USB control unit 30B transfers the compression image processing data to the data communicating unit 40B.

When the compression image processing data is received, the data communicating unit 40B refers to the memory 40D, obtains the ID information corresponding to the image output apparatus 2 on the basis of the driver for the image output apparatus of the transmitting source side, and inserts the ID information into the compression image processing data, thereby forming identification compression image processing data and transferring the identification compression image processing data to the USB data buffer 40C (step S3).

When the identification compression image processing data is transferred to the USB data buffer 40C, the USB control unit 30B of the upper apparatus 3 transmits the identification compression image processing data to the USB data buffer 20E through the USB control unit 10I of the image input apparatus 1 (step S4).

When the identification compression image processing data is transferred to the USB data buffer 20E, the USB control unit 101 transfers the identification compression image processing data to the peripheral apparatus control unit 20D.

The peripheral apparatus control unit 20D analyzes the received identification compression image processing data. When the ID information of the image output apparatus 2 and the compression image processing data are obtained, the peripheral apparatus control unit 20D determines on the basis of the ID information that the transfer destination of the compression image processing data is the image output apparatus 2 and transfers the compression image processing data to the PC print control unit 10G through the USB control unit 101 (step S5).

When the compression image processing data is received from the peripheral apparatus control unit 20D, the PC print control unit 10G transfers the compression image processing data to the USB data buffer 20E of the USB control unit 10I.

When the compression image processing data is transferred to the USB data buffer 20E, the USB control unit 10I transmits the compression image processing data to the USB data buffer 60E through the USB control unit 50D of the image output apparatus 2 (step S6).

When the USB data buffer 60E receives the compression image processing data, the USB control unit 50D transfers the compression image processing data to the decoding unit 50B.

When the compression image processing data is received, the decoding unit 50B executes the decoding process to the compression image processing data, obtains the image processing data, stores the image processing data into the image memory 60A, and outputs a decoding process completion signal to the printer control unit 50 (step S7).

When the decoding process completion signal which is outputted from the decoding unit 50B is received, the printer control unit 50 obtains the image processing data from the image memory 50A and transfers the image processing data to the print unit 50C. The print unit 50C executes the print process based on the received image processing data, so that the PC print process is completed.

The operation of the copy function using the multi-function system of the invention will now be described.

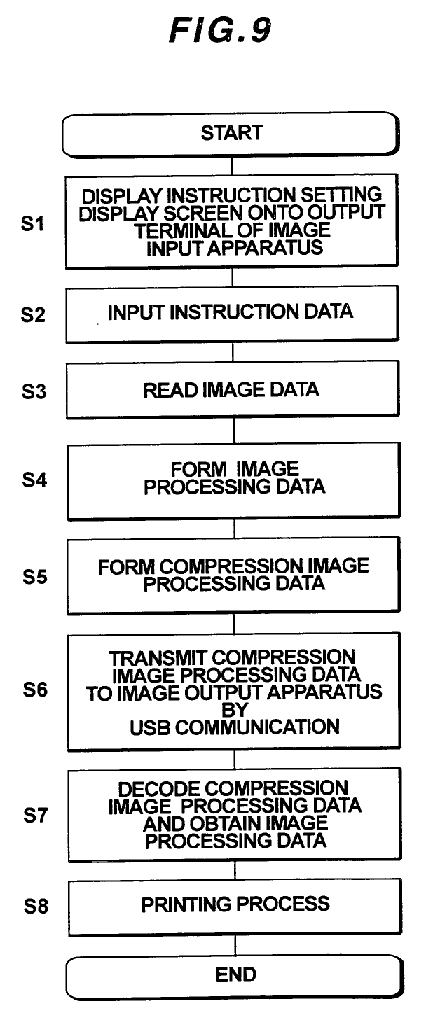

FIG. 9 is an operation flowchart for the copy function using the multi-function system of the invention.

When the original is put on the reading unit 10B of the image input apparatus 1 and the copy function selection signal to select the copy function is outputted to the scanner control unit 10 from the input unit of the operation unit 10H, the scanner control unit 10 instructs the operation unit 10H to display an instruction setting display screen for receiving an instruction of the copy operation control.

When the instruction to display the instruction setting display screen is received, the operation unit 10H displays the instruction setting display screen through the output unit (step S1).

When the reading instruction data, image processing instruction data, and compression instruction data are inputted by the operator on the basis of the instruction setting display screen, the operation unit 10H transfers the respective instruction data to the copy control unit 10E (step S2).

When the respective instruction data is received, the copy control unit 10E holds the instruction data into the memory (not shown) and, first, transfers the reading instruction data to the reading unit 10B.

The reading unit 10B reads the original on the basis of the received reading instruction data, forms the image data, stores the image data into the image memory 10A, and outputs a reading process completion signal to the copy control unit 10E (step S3).

When the reading process completion signal which is outputted by the reading unit 10B is received, the copy control unit 10E transfers the image processing instruction data to the image processing unit 10C.

When the image processing instruction data is received, the image processing unit 10C obtains the image data from the image memory 10A, executes the image process to the image data on the basis of the image processing instruction data, forms the image processing data, stores the image processing data into the image memory 10A, and transfers an image process completion signal to the copy control unit 10E (step S4).

When the image process completion signal which is outputted by the image processing unit 10C is received, the copy control unit 10E transfers the compression instruction data to the compressing unit 10D.

When the compression instruction data is received, the compressing unit 10D obtains the image processing data from the image memory 10A, executes the compressing process to the image processing data on the basis of the compression instruction data, forms compression image processing data, stores the compression image processing data into the image memory 10A, and transfers a compressing process completion signal to the copy control unit 10E (step S5).

When the compressing process completion signal which is outputted by the compressing unit 10D is received, the copy control unit 10E obtains the compression image processing data from the image memory 10A and transfers the compression image processing data to the USB data buffer 20E of the USB control unit 10I.

When the compression image processing data is transferred to the USB data buffer 20E, the USB control unit 10I transmits the compression image processing data to the USB data buffer 60E of the USB control unit 50D of the image output apparatus 2 (step S6).

When the compression image processing data is transferred to the USB data buffer 60E, the USB control unit 50D transfers the compression image processing data to the decoding unit 50B.

The decoding unit 50B executes the decoding process to the received compression image processing data, obtains the image processing data, stores the image processing data into the image memory 50A, and outputs a decoding process completion signal to the printer control unit 50 (step S7).

When the decoding process completion signal is received from the decoding unit 50B, the printer control unit 50 obtains the image processing data from the image memory 50A, and transfers the image processing data to the print unit 50C. The print unit 50C executes the print process based on the received image processing data, thereby completing the copy process (step S8).

According to the multi-function system of the embodiment, in order to allow the upper apparatus 3 to establish the communication with the image input apparatus 1 and the image output apparatus 2, the image input apparatus 1 transmits the descriptor for the image input apparatus and the descriptor for the image output apparatus to the upper apparatus 3, and the upper apparatus 3 establishes the communication with each of the image input apparatus 1 and the image output apparatus 2 on the basis of both of the descriptors. Therefore, the upper apparatus 3 can recognize the image input apparatus 1 and the image output apparatus 2 connected to the image input apparatus 1.

Thus, the upper apparatus 3 can make the image input apparatus 1 and the image output apparatus 2 execute the multi-operation, so that the business processing efficiency can be improved.

Since each of the image input apparatus 1 and the image output apparatus 2 can be recognized from the upper apparatus 3, there is no need to provide an expensive USB controller for the upper apparatus 3.

Further, in the case of adding a new peripheral apparatus, since the peripheral apparatus driver of those peripheral apparatuses is used, the peripheral apparatus can be added without developing a new peripheral apparatus driver. Therefore, the addition of the functions can be easily realized.

Although the above embodiment has been described by limiting the peripheral apparatuses to the image input apparatus and the image output apparatus, the invention is not limited to them. For example, a facsimile apparatus, an image server apparatus, and the like can be mentioned as peripheral apparatuses and the invention can be also applied to them.

The present invention is not limited to the foregoing embodiment but many modifications and variations are possible within the spirit and scope of the appended claims of the invention.

What is claimed is:

1. A multi-function system in which one of a plurality of peripheral apparatuses is connected as a specific parent peripheral apparatus to an upper apparatus and said residual peripheral apparatuses are connected as child peripheral apparatuses to said parent peripheral apparatus, wherein
said parent peripheral apparatus has a descriptor transmitting unit which transmits peripheral apparatus descriptors necessary for defining said parent peripheral apparatus and said child peripheral apparatus to said upper apparatus,
said upper apparatus has
a first control unit which gives identification information to said parent peripheral apparatus and said child peripheral apparatuses on the basis of said peripheral apparatus descriptors each time the peripheral apparatus descriptors are received and
a data communicating unit which forms identification communication data to specify said parent peripheral apparatus and said child peripheral apparatuses serving as transmission destinations of communication data to be transmitted to each of said peripheral apparatuses and transmits said identification communication data to said parent peripheral apparatus, and
further, said parent peripheral apparatus has a peripheral apparatus control unit which, when said identification communication data is received, analyzes the identification communication data, obtains said identification information, discriminates a transfer destination of said communication data on the basis of said identification information, and transfers the communication data.

2. The multi-function system according to claim 1, wherein said parent peripheral apparatus has a second control unit which, when said peripheral apparatus descriptor is received from said child peripheral apparatus, makes the device definition of said child peripheral apparatus in said parent peripheral apparatus on the basis of said peripheral apparatus descriptor and gives said identification information to said child peripheral apparatus.

3. The multi-function system according to claim 1, wherein said parent peripheral apparatus is a scanner, said child peripheral apparatus is a printer.

4. The multi-function system according to claim 3, wherein said upper apparatus is connected with said scanner via USB cable, and said scanner is connected with said printer via USB cable.

5. The multi-function system according to claim 3, wherein, when said peripheral apparatus control unit judges said communication data should be processed by its own on the basis of said identification information, said scanner executes scanning process to obtain image process data on the basis of said communication data.

6. The multi-function system according to claim 3, wherein, said printer, when received said communication data from said peripheral apparatus control unit, executes printing process on the basis of said communication data.

7. The multi-function system according to claim 3, wherein,
said scanner further includes a operation unit to receive an input of instruction data for executing copying process containing a scanning process and a printing process; and a copy control unit, when said instruction data is input to said operation unit, to execute said scanning process on the basis of said instruction data for obtaining image process data and to send said obtained image process data to said printer,
said printer, when received said image process data, executes said printing process on the basis of said image process data.

8. The multi-function system according to claim 1, wherein said parent peripheral apparatus is an image input apparatus and said child peripheral apparatus is an image output apparatus.

9. The multi-function system according to claim 8, wherein said parent peripheral apparatus is scanner, said child peripheral apparatus is printer.

10. The multi-function system according to claim 9, wherein said upper apparatus is connected with said scanner via USB cable, and said scanner is connected with said printer via USB cable.

11. The multi-function system according to claim 9, wherein, when said peripheral apparatus control unit judges said communication data should be processed by its own on the basis of said identification information, said scanner executes scanning process to obtain image process data on the basis of said communication data.

12. The multi-function system according to claim 9, wherein, said printer, when received said communication data from said peripheral apparatus control unit, executes printing process on the basis of said communication data.

13. The multi-function system according to claim 9, wherein,
said scanner further includes a operation unit to receive an input of instruction data for executing copying process containing a scanning process and a printing process; and a copy control unit, when said instruction data is input to said operation unit, to execute said scanning process on the basis of said instruction data for obtaining image process data and to send said obtained image process data to said printer,
said printer, when received said image process data, executes said printing process on the basis of said image process data.

14. The multi-function system according to claim 8, wherein said parent peripheral apparatus has a second control unit which, when said peripheral apparatus descriptor is received from said child peripheral apparatus, makes the device definition of said child peripheral apparatus in said parent peripheral apparatus on the basis of said peripheral apparatus descriptor and gives said identification information to said child peripheral apparatus.

15. An image input apparatus to which at least one peripheral apparatus has been connected as a child peripheral apparatus and which receives communication data that is outputted from an upper apparatus and should be supplied to either its own apparatus or said peripheral apparatus, comprising:
a descriptor transmitting unit which transmits peripheral apparatus descriptors necessary for defining said own apparatus and said peripheral apparatus to said upper apparatus; and
a peripheral apparatus control unit which, when identification communication data to specify a transmission destination including identification information showing either said own apparatus or said peripheral apparatus is received from said upper apparatus, analyzes said identification communication data, and when said identification information indicates said peripheral apparatus, transfers said communication data to said peripheral apparatus.
